(19) United States
(12) Patent Application Publication
(10) Pub. No.: US 2004/0101615 A1
(43) Pub. Date: May 27, 2004

(54) Edible substrates

(76) Inventors: Dawn Barker, Ashington (GB); Andrew Candler, Morpeth (GB); Fergal Keohane, Jesmond (GB); Denise Metcalfe, Ashington (GB); John Russell, Bedlington (GB); Julie Sellick, Bedlington (GB); Angela Wright, Ashington (GB)

Correspondence Address: FISH & RICHARDSON P.C., 3300 DAIN RAUSCHER PLAZA, 60 SOUTH SIXTH STREET, MINNEAPOLIS, MN, 55402, US

(21) Appl. No.: 10/391,305

(22) Filed: Mar. 18, 2003

(30) Foreign Application Priority Data
Nov. 27, 2002 (GB) 0227663.2

(51) Int. Cl. A23L 1/05

(52) U.S. Cl. 426/661

(57) ABSTRACT

An edible composition can include an emulsifier; a plasticizer; a stabilizer; a humectant; a texturizer; starch; and water. Such a composition, when formed into a substantially non-flowable substrate, is stable in an environment having a temperature of about −35° C. to about 275° C., and a humidity level greater than about 5%.

### RELATED APPLICATIONS

This application claims priority from GB Application No. 0227663.2, filed on Nov. 27, 2002, the disclosure of which is hereby incorporated by reference.

### TECHNICAL FIELD

This invention relates to edible substrates, and more particularly to starch-based printable edible substrates.

### BACKGROUND

Decorations or adornments are often placed on foodstuffs, such as pastries, iced cakes, pasties, ice cream, baked goods, and meat products. A popular decoration is a decorative image that can be transferred onto a surface of a food item, such as a cake. Typically, the decorative image is printed (e.g. screen printed) on an edible carrier or substrate which lays on a release layer or liner (e.g. paper). The substrate can then be transferred onto a target surface of the food item.

Use of decorative images has worldwide popularity, therefore although a substrate may be compatible with high-speed manufacturing, it still must meet the standards of printability and durability when exposed to a wide range of humidity and temperature levels. Conventional substrates that contain hydrophilic materials may have limited use, for example, in areas of the world where humidity is high. Substrates with components that soften easily may also have limitations, especially in geographic areas that experience high temperatures, such as above 32° C.

What is desired is an edible printable substrate that can be made using a variety of manufacturing techniques, and can be used in a broad range of environmental conditions, so that the substrate maintains its integrity during packaging, handling, and during image transfer.

### SUMMARY

In various embodiments, a formulation may be provided for an edible composition that includes an emulsifier; a plasticizer; a stabilizer; a humectant; a texturizer; starch; and water. An exemplary composition, when formed into a substantially non-flowable substrate, is stable in an environment having a temperature about −35° C. to about 275° C., and a humidity level greater than about 5%.

In an aspect, a composition can include up to about 10 wt % emulsifier; up to about 10 wt % plasticizer; up to about 16 wt % stabilizer; about 5 wt % to about 35 wt % humectant; about 1 wt % to about 20 wt % texturizer; starch; and water, wherein the weight percentages are based on the total weight of the composition.

In certain embodiments, a method of making a substrate from an edible composition may be provided, where liquid ingredients and dry ingredients are separately mixed, and then combined to provide a flowable mixture which can then be formed into a substrate. In other methods, a fatty phase mixture is additionally prepared and heated, and then combined into the liquid ingredients mixture. The dry ingredients mixture is then added to the mixture of liquid and fatty phase.

Various embodiments of the invention can be used in a wide variety of environmental conditions, ranging from a frozen environment to elevated cooking temperatures, as well as from dry to high humidity conditions. A substrate made from certain compositions of the invention can be partially solidified, such as in a non-flowable state, and exhibits stability in broad temperature and humidity ranges. A substrate adaptable to a variety of manufacturing techniques can be formed; certain substrates even adaptable to rapid manufacturing processes.

The details of one or more embodiments of the invention are set forth in the accompanying drawings and the description below. Other features, objects, and advantages of the invention will be apparent from the description and drawings, and from the claims.

### DETAILED DESCRIPTION OF ILLUSTRATIVE EMBODIMENTS

Certain embodiments of the invention provide edible compositions that can be formed into a printable edible substrate using a variety of techniques. Substrates made from certain compositions can be stable within a wide range of temperature and humidity conditions. The edible compositions can be layered or coated onto a compatible release liner and presented in a format compatible with in-line printing, off-set printing, or other image transferring techniques. An image-bearing substrate can then be easily positioned on a surface of a food product to serve as decoration or adornment. For certain foods, further processing such as heating or other cooking can be performed without any substantial detrimental effects to the quality of the substrate or an image imprinted on the substrate.

Compositions according to the invention generally may contain starch, water and ingredients that cooperate to provide a formulation that can be made using a variety of substrate manufacturing techniques and result in substrates that are environment tolerable. In particular, components in a starch-based composition can include, for example, an emulsifier, a plasticizer, a stabilizer, a humectant, and a texturizer. Depending on the total amount of each ingredient and the types of ingredients present in the composition, a specific component or ingredient can be multi-functional and serve in one or more of the described capacities.

The starch in the composition can be used to primarily provide a base solid material or structure forming material. The starch can be used in unrefined, refined, unmodified or modified form. Exemplary starches include those based from maize (corn), potato, wheat, and tapioca starch. The amount of starch in a composition of the invention can be about 5 wt % to about 28 wt %, a suitable range also being about 6 wt % to about 25 wt %. Certain compositions can include about 8 wt % to about 15 wt % starch. Gum acacia can optionally be included with the starch, adding to the structure forming material, at concentrations up to about 17 wt %.

Water can be present in the composition at about 25 wt % to about 70 wt % of the total weight of the composition. Certain embodiments can have about 28 wt % to about 52 wt % water, and particular formulations can have about 35 wt % to about 45 wt %. Other useful compositions can have about 50 wt % to about 65 wt % water.

Including an emulsifier in an edible composition in accordance with an exemplary formulation of the invention can be beneficial in ensuring homogeneity. The amount of emulsifier in a composition can be up to about 10 wt % of the total composition. Exemplary compositions can include up to about 5 wt % emulsifier, and other compositions can include about 0.5 wt % to about 1.5 wt % emulsifier. Suitable emulsifiers include for example, lecithin, polyglycerol polyricinoleate, acetic esters of monoglycerides, polyoxyethylene sorbitan monostearate (e.g. commercially available products such as POLYSORBATE 60, CRILLET, CRILLET VEG A, and TWEEN), and combinations thereof. A useful emulsifier is a product commercially available under the trade designation POLYSORBATE 60. Combinations of suitable emulsifiers can also be used in the composition. Substrates made from an exemplary composition according to the invention can exhibit an improved capability of holding (bearing) an applied image when the composition include an effective amount of emulsifier. This helps achieve and maintain the clarity of an image applied to a substrate.

Including a plasticizer in the composition can impart a peelable, flexible characteristic to a resultant substrate made from a composition of the invention. Providing a flexible substrate can be beneficial in certain image printing techniques, such as off-set printing, where the substrate may need to be manipulated in, for example, axial or radial directions. The plasticizer is also useful for ensuring that a substrate is peelable or removable from its carrier, such as a release liner. Transferring a substrate to a target food item is desirably accomplished without structural defects to the substrate, such as flaking, fracturing, etc. A preferred plasticizer is glycerin. Thus, easy or smooth removal from a release liner can prevent such damage. Compositions according to the invention can include up to about 10 wt % plasticizer; up to about 5 wt % plasticizer is also suitable for exemplary compositions.

A stabilizer can be useful in an edible composition to prevent separation of the ingredients, such as the solids from the liquids, or the fatty phase from the aqueous phase. Including a stabilizer also helps maintain the viscosity necessary to process the composition. A stabilizer can be present in the composition at up to about 16 wt %, based on the total weight of the composition. In an aspect, a stabilizer can be included at about 2 wt % to about 6 wt %; other compositions can include about 5 wt % to about 12 wt % stabilizer. Examples of useful stabilizers for the composition include one or more ingredients chosen from locust bean gum, arabic gum, acacia gum, polysorbate, sodium alginate, starch, xanthan, acetic esters of monoglycerides, and polyglycerol polyricinoleate, sorbitol, and starch. In exemplary embodiments, a stabilizer can advantageously work in additional capacities, such as a suspension agent, or a thickener (e.g. viscosity modifier). Acacia gum, for example, can function as a stabilizer in the composition, yet can also impart thickening and structure forming features. When used as a viscosity modifier, a stabilizer can be present in a composition in any amount that imparts sufficient viscosity so that a composition is processable (e.g. spreadable). Many substrate manufacturing techniques, such as spray coating, screen printing, and slot coating typically require a composition to have a viscosity of about 1000 to about 9000 centipoise (cP). Lower viscosity compositions may be more conducive to spray coating, while the higher viscosity compositions tend to be capable of being processed by coating (e.g. slot coating) or screen printing, for example. Achieving a lower viscosity composition may involve adding higher amounts of water (e.g. greater than about 50 wt %) and/or adjustments to the concentration of other constituents of the composition. These compositions, having a viscosity of about 1000 to about 2000 cP, can be particularly suitable for spray applications.

A humectant can be present in the composition at about 5 wt % to about 35 wt % of the composition, and can be achieved by using one or more of, for example, sorbitol, glycerine, and sugars, such as icing cane sugar (e.g. sucrose), fondant icing sugar, xylitol, glucose, and fructose. Useful formulations for exemplary compositions include about 2 wt % to about 6 wt % humectant, and also about 6 wt % to about 10 wt % humectant; while others can include 10 wt % to about 16 wt %. Humectants can be used to retain the moisture of a composition and thereby impart flexibility to the composition once it has been formed into, for example, a substrate. Desirably, substrates are sufficiently flexible so it can be handled without fracturing or falling apart.

Compositions of the invention can also include a texturizer, an ingredient that can help a mixture flow, such as what occurs when substrates are made. A texturizer can retain and/or bind the water, to provide a flowable, pourable, coatable, extrudable or sprayable composition. Materials that can be used as the texturizer include, but are not limited to, acacia gum, Arabic gum, glucose, fructose, sucrose, and combinations thereof. The texturizer can be present in the composition at about 1 wt % to about 20 wt %, and also between about 7 wt % to about 15 wt %.

Substrates made in accordance with the invention can be used for decorating confectionary foods that are often cut into individual pieces, such as what is often done with a cake. In these applications, it is generally desirable that the substrate easily cuts without fraying or fracturing and maintains the integrity of an image (if one exists on the substrate). This cuttability feature can be achieved by optionally using a disintegrant. The disintegrant can be present up to about 12 wt %, however, the amount can be adjusted according to a particular application of a substrate. A useful disintegrant material is microcrystalline cellulose.

Other optional additives that can be included in compositions of the invention including, but not limited to, sweeteners, color enhancing agents, preservatives, flavoring, and rheology modifiers. Suitable sweeteners include for example, sorbitol, glucose syrup, fructose, sucrose, dextrose, aspartame, and sugars such as icing cane sugar and fondant icing sugar. Use of sweeteners can also be beneficial in applications where a composition is made into a freezable substrate since a sweetener can change (e.g. depress) the freezing point and also aid in freeze-thaw stability of a substrate. Certain sweeteners such as sorbitol, have many useful characteristics that impart various features to the composition beyond just sweetening; therefore it can be beneficial to use sorbitol as a sweetener as it may serve other functions in the composition as described above. Dextrose, in the form of dextrose monohydrate can also be useful, as it can add smooth and cooling taste to the composition. In an embodiment of the invention, the sweetener can be in a composition at a concentration up to about 30 wt %, a suitable range also being about 5 wt % to about 15 wt %. The amount of sweetener, however, can be adjusted according to a desired taste. Color enhancing agents can be, for example, whiteners, colorants, inks, dyes, or pigments. Certain substrates are often desirably whitened for aesthetic reasons, particularly when used for decorating pastries such as cakes, cupcakes, and the like. A popular whitening agent for confectionary applications is titanium dioxide. In the practice of the invention, up to about 4 wt % titanium dioxide can be used in an exemplary composition. Any known pigment approved for human consumption may be used as the color enhancing agent, including, for example, carmoisine, quinoline, ponceau 4R, blue 1, vegetable carbon, blue V, blue 2, and FD&C pigments such as yellow 5, red 3, red 40, blue 1, and blue 2. A preservative can be added to a composition to increase the shelf life and inhibit microbial growth (e.g. microorganisms including, but not limited to yeast, mold, bacteria). Up to about 1 wt % of a preservative can be added to an exemplary edible composition of the invention. Examples of useful food preservatives for the compositions of the invention are citric acid, potassium sorbate, sorbic acid, sodium benzoate, EDTA and combinations thereof. Flavoring agents for embodiments of the invention can include citric acid, vanilla, and any other edible natural or artificial flavorant. The flavoring agent can be present up to about 1 wt % of the composition.

Optionally, a fatty phase comprising oil can be included in a composition of the invention as a rheology modifier. The oil can be any edible oil, and preferably a vegetable oil, such as one derived from for example, rapeseed, corn, and soy. A combination of oils can also be used. In an embodiment, rapeseed oil is used to enhance the behavior of the composition as it is applied to a backing such as a release liner. In particular, rapeseed oil can assist and enhance the composition's ability to coat (e.g. lay or spread on) a waxy release liner. An oil can be present in a composition at up to about 15 wt % of the total composition.

According to a process of the invention, a composition can be made by first dry blending all the dry ingredients except the color enhancing agent if used. The liquid ingredients, including the emulsifier are then blended together into a separate mixture. The optional color enhancing agent is then added to the liquid mixture and dispersed therein using a high shear mixer. This mixing is generally performed for approximately 5 minutes, although the mixing time can be adjusted according to amounts used. The fatty phase ingredients (e.g., lecithin and/or oil) are initially heated to, for example about 70-80° C. and then added to the liquid mixture and dispersed therein using a high shear mixer. Finally, the liquid mixture (with fatty phase) is then added to the blended dry ingredients and mixed for a sufficient time to achieve a well-mixed blend. Mixing time for the final blend can typically take, for example, 5 minutes, although time adjustments can be necessary for larger or smaller volumes of compositions, or for equipment that may have different mixing speeds and capacities.

Substrates can be made from exemplary compositions of the invention. In particular, such substrates can be edible and can bear an image. To form a substrate, one or more techniques can be used to provide a substantially planar layer. Suitable techniques include, for example, slot coating or spraying the composition onto a carrier, or extruding, molding or screen printing the composition. Typically, the layer of material is allowed to solidify to a certain extent, so that further processing can be performed. In an aspect, the formed layer of composition is typically suitable for further processing when it is substantially non-flowable. This ensures that the material does not lose its shape or develops any defects while it is handled in the subsequent processing steps. A substantially non-flowable state generally represents the behavior of a substrate as it is positioned on a substantially horizontal carrier, without being subjected to additional forces (e.g. vacuum or pressure), centrifugal forces or other forces. Although a substantially non-flowable substrate may exhibit some very slow creep, the substrate would not likely move or show deformation unless it was tilted or contacted with an instrument or other object. To achieve a non-flowable state, at least a portion of the water in the composition is allowed to evaporate or be absorbed by the components in the composition. The substrate need not be fully solidified prior to further processing, since the drying/solidification process can continue and progress throughout an entire manufacturing process and possibly into the storage time. In general, a substrate can be handled and manipulated once the composition has reached a semi-solid state.

To accelerate the process for achieving a semi-solid or non-flowable state, a composition can optionally be subjected to heat, such as by the use of ovens, to remove water from the composition. Any type of heat producing equipment is suitable, including, but not limited to, conventional ovens, IR dryers, convection ovens, microwaves, etc. In an exemplary method, water can be removed by drying the substrate in an oven for about 20 to about 40 minutes, at an average temperature of about 50° C. While not intending to be bound by theory, it is estimated that approximately 90 to about 95% of the water can be removed after about 40 minutes at 50° C., for substrates that are less than about 650 micrometers (μm) thick. The time and temperature ranges can be adjusted to correspond with a substrate thickness as well as the type and capacity of the heating equipment. As a final product, as it would be presented to its packaging, or at the point of transferring onto a food item, a substrate typically has enough moisture so that it is sufficiently flexible so it does not fracture, yet can be removed from a release liner if one is present. For example, a substrate can have about 5 to about 10% moisture.

In accordance with the invention, a substrate can be packaged and/or stored until a later time, for handling and processing in a separate process or facility or by a subsequent manufacturer or printer. Packaging such as bags, envelopes, boxes, and the like can be used to wrap and protect a substrate. Any conventional food packaging material can be used, but particularly useful materials are those that are would not have any deleterious effects on a substrate. Packaging having a good moisture vapor barrier is useful. Substrates made from certain compositions of the invention can maintain their stability when packaged in a substantially impervious container, particularly if the packaging can maintain the moisture retained in the substrate. Exemplary materials that packaging can be made from and are suitable for a substrate according to the invention include for example, polypropylene films, polyester films such as MYLAR® (E.I. du Pont de Nemours and Company; Wilmington, Del.), foils (e.g. aluminum) and the like. A printed or unprinted substrate made from a composition of the invention can be stored in a freezer, or at room temperature. A cool environment can be conducive to maintaining freshness of the substrate. Upon removal from a cooler or freezer, a substrate can be thawed and subsequently used to accept a transferred image, or can be directly adhered to a food item. A substrate, whether or not it bears an image, advantageously does not suffer deleterious effects when subjected to a freeze thaw regiment.

The substrate can be made in sheet form, roll form, or pre-determined shapes. In any of these formats, the substrate generally takes on a substantially planar dimension. Optionally, the substrate can be trimmed to remove excess, frayed or unusable side trim, or can be cut to a desired size and shape. The thickness of substrates can be any size suitable for printing processes and sized to fit and adhere on a food item. Typically, a substrate has an average thickness of up to about 650 micrometers (μm). In applications where the substrate is desirably thin, the substrate can be as thin as about 50 micrometers. Thicker substrates can also be made, if desired, particularly when an image transfer or printing process does not limit the substrate thickness. It is also contemplated that certain substrates can have a topography; therefore thicker substrates, or substrates with particular portions varying in thickness, can be provided.

An image can be placed onto a surface of a substrate using any suitable process, such as a silk screen printing process, offset printing, thermal transfer, ink jetting, etc. An image can include, for example, informative indicia (e.g. dates, names, etc); pictures or illustrations of people, places and things; patterns; decorative art; and other aesthetic images. Substrates made according to embodiments of the invention can exhibit ability to hold and maintain the quality and integrity of an applied image. For example, images applied with an edible ink can be placed on certain substrates and maintained such that no significant or undesirable bleeding, fading, refractivity, haziness occurs. An image can be quite clear and aesthetically pleasing when applied onto a whitened substrate, such as those made from compositions according to the invention that include a whitening agent. Substrates with increased opacity can provide clear images, typically when used on food items such as frosted cakes and other pastries.

An image can be applied in-line, as a substrate is made, just after a substrate reaches its non-flowable state, or at a later stage in a manufacturing process. It is may be possible that a non-image bearing substrate can be initially applied to a surface of a food item and then positioned to receive an image. Again, this can occur in-line, or off-line. Numerous types of edible or comestible products can have a substrate applied to it. Items, such as, but not limited to, pastries, iced cakes, pasties, ice-cream, cream, candy, vegetables, and meat products are food items that can be decorated, adorned or enhanced by a substrate according to the invention. An image can be made from an edible ink formulation, applied to the substrate in any suitable printing apparatus or process. For example, printing processes that may be used include silk screen, wet offset, lithographic blanket transfer, flexographic Anolux roller transfer, letter press rotary relief plate, web print, reel to reel, and gravure. Suitable printing apparatus include dry offset printers available from Heidelberg Druckmaschinen AG, Heidelberg, Germany, A.B. Dick-Itek Limited, Middlesex, England and Sakurai Machinery, Koto-ku, Tokyo, Japan.

Exemplary compositions, when made into planar substrates, demonstrate high tolerance to extreme temperatures and levels of humidity. In one embodiment of the invention, a substrate (whether it is imprinted upon or not) is capable of withstanding a freeze thaw regime without suffering any deleterious affects thereto. Thus, substrates made from a composition of the invention can be conveniently frozen (e.g. manufactured, stored etc.) at about 0° C. or less, and allowed to thaw at, for example, room temperature, when ready for use or handling (e.g. shipping). A substrate made from a composition of the invention can be also be, for example, frozen, thawed, and then heated to, for example, cooking temperatures. In an aspect, a substrate can be stable in freezing temperatures, yet maintain its integrity even after being subjected to cooking temperatures, such as above 75° C. It has been found, for example, that image-bearing substrates made from certain compositions according to the invention demonstrate an ability to maintain the integrity of the substrate and the quality of an image (e.g. definition and clarity) after being exposed to baking conditions (e.g. temperatures greater than about 93° C.). Thus the image bearing substrate can be placed on a partially processed or unprocessed food product before being subjected to the final cooking process, which can be any of a variety of methods such as baking, grilling, frying, broiling, etc. These cooking techniques can sometimes reach up to about 275° C. However, for deep frying, for example, the temperature range can be lower, depending what type of oil is used. With certain compositions, a substrate can be made to optionally expand with its target food item, such as what occurs with dough-based products. Upon expansion, the image can maintain its definition even as the product becomes fully processed.

A temperature range in which a substrate according to the invention can be stable is from about −35° C. to about 275° C. Edible compositions can be formulated to provide substrates that are stable within about 0° C. to about 20° C., while others can withstand temperatures of about 18° C. to about 32° C. and maintain their stability. Stability can be in regards to the structure of the substrate, as well as its freshness (e.g. edibility, taste, color, etc). A stable substrate would not, for example, experience any significant and/or unexpected softening or hardening which would make it difficult to process for image application or for placement onto a food item. Some softening can occur when a substrate is subjected to added heat, such as in cooking. However, this would not be considered instability, as the softening is expected and desirable, and can help keep the substrate in place on the food surface. A stable substrate also describes one that does not fall apart upon any process-appropriate handling. Furthermore, a stable substrate would typically not experience any significant or undesired discoloration or change in taste.

A substrate formed from a composition described herein can be highly tolerable to both low and high humidity levels. Environments of substantially no to low humidity, such as about 5% RH (relative humidity) typically would not affect the integrity of the substrate. Thus, a substrate made from a composition according to the invention can be stable in an environment having greater than about 5% humidity. Even more advantageously, a substrate can be tolerable of high humidity levels. For example, a substrate according to the invention can be stable above about 50% RH, a humidity level at which conventional substrates can experience detrimental effects. Certain substrates can even withstand humidity levels of up to about 100%. In high humidity conditions, exemplary compositions of the invention that are formed into substrates as a layer on a compatible backing or release liner can conveniently be transferred to a food item without fracturing or falling apart.

Conventional release liners can be used as a backing to support a substrate. Suitable materials for a backing to hold or carry a substrate include, but are not limited to, corona-treated paper, wax coated paper, polymeric films, plastic, cellulose, polyethylene, or polypropylene coated paper, and the like. Preferred release liners are those in which a composition can be applied (by e.g. pouring, coating, spraying, screening, etc.) yet can also separate from a semi-solid substrate without damaging (e.g. fracturing) the substrate.

Materials and processes described herein can be modified to comply with applicable standards such as FD&C regulations in the United States and E.E.C. standards in the European Union.

The following non-limiting examples are provided for illustrative purposes and are not intended to limit the scope of the invention.

### EXAMPLES

### Example 1

A composition with the ingredients listed in Table 1 was made by first mixing the dry ingredients, except the titanium dioxide. The liquid ingredients were then mixed together. The fatty phase ingredients were heated to about 70°-80° C. and then admixed to the liquid mixture. The dry mixture was then mixed to the liquid/fatty phase mixture and blended well. All the mixing was performed with a high shear homogenizer.

An amount of the composition was coated onto a wax coated paper as a sheet (approximately 30.5 cm×30.5 cm) and oven dried in a series of heat treatments that averaged to about 50° C. and totaled forty minutes of oven baking. The heat treatments were performed in an oven equipped with an infrared heating element (IRT-Monocassette w/Control Unit from Solaronics IRT S.A.; Armentieres, France). The composition layer was considered to be substantially non-flowable after some oven heating, and considered fully cured prior to applying an image thereon. Various sample sizes and shapes were cut (e.g. die-cut) from the substrate sheets, all samples dimensioned to fit on a food item. Each sample was then applied to a food item and subjected to cooking conditions, including baking, grilling and frying.

Samples that were baked were placed on biscuits, scones or pies then heated to about 160° C. to about 250° C. Samples that were deep fried were applied on chicken pieces (e.g. nuggets) and sausage rolls, and then fried at about 180 to about 200° C. Grilled samples were chicken and fish pieces that bore imaged substrate samples; these were grilled at 160 to about 200° C.

All samples cooked according to techniques described above were observed to be stable and capable of maintaining the quality of the image even after the cooling step.

TABLE 1

| | | % by wt. | Wt. in Kg |
|---|---|---|---|
| Dry | Gum Acacia | 14.04 | 6.06 |
| Ingredients | Maize Starch | 13.34 | 5.76 |
| | Microcrystalline | 1.95 | 0.84 |
| | Cellulose | | |
| | Xanthan | 0.70 | 0.30 |
| | Titanium Dioxide | 2.90 | 1.25 |
| | Modified Starch | 0.49 | 0.21 |
| | Potassium Sorbate | 0.14 | 0.06 |
| Liquid | Water | 41.70 | 18.00 |
| Ingredients | Sorbitol | 9.27 | 4.00 |
| | Glycerine | 4.63 | 2.00 |
| | Polysorbate 60 | 0.97 | 0.42 |
| | Vanilla Flavoring | 0.12 | 0.05 |
| Fatty | Lecithin | 0.51 | 0.22 |
| Phase | Rapeseed Oil | 9.27 | 4.00 |
| | Total | 100.00 | 43.17 |

### Example 2

A composition with the ingredients and amounts listed below in Table 2 was made in similar fashion to the mixing procedure of Example 1.

TABLE 2

| | | % By Wt. | Wt. in Kg |
|---|---|---|---|
| Dry | Maize Starch | 14.48 | 6.91 |
| Ingredients | Microcrystalline Cellulose | 6.34 | 3.02 |
| | Gum Acacia | 6.24 | 2.98 |
| | Icing Cane Sugar | 5.03 | 2.40 |
| | Dextrose Monohydrate | 4.23 | 2.02 |
| | Titanium Dioxide | 3.15 | 1.50 |
| | Modified Starch | 0.50 | 0.24 |
| | Citric Acid | 0.30 | 0.14 |
| | Potassium Sorbate | 0.08 | 0.04 |
| | Xanthan | 0.30 | 0.14 |
| Liquid | Water | 40.24 | 19.20 |
| Ingredients | Glucose liquid | 9.36 | 4.46 |
| | Glycerine | 3.72 | 1.78 |
| | Polysorbate 60 | 1.11 | 0.53 |
| | Sorbitol | 0.40 | 0.19 |
| | Vanilla flavoring | 0.10 | 0.05 |
| Fatty | Rapeseed Oil | 4.02 | 1.92 |
| Phase | Lecithin | 0.40 | 0.19 |
| | Total | 100. | 47.72 |

Substrates made from this composition were frozen and then thawed to room temperature. It was observed that the freeze-thaw regiment did not result in any significant detrimental effects on the substrate. Samples of the substrate were also subjected to a high humidity environment. The samples remained stable.

### Example 3

A composition having the following ingredients and amounts as provided below in Table 3 was prepared.

TABLE 3

| | | Wt. % |
|---|---|---|
| Dry | Gum Acacia | 8.81% |
| Ingredients | Microcrystalline Cellulose | 1.17% |
| | Xanthan | 0.59% |
| | Titanium Dioxide | 0.59% |
| | Modified Starch | 0.44% |
| | (Pre-gelatinised Waxy | |
| | Maize Starch) | |
| | Aspartame | 0.06% |
| | Potassium Sorbate | 0.09% |
| | Maize Starch | 8.37% |
| Liquid | Sorbitol | 8.81% |
| Ingredients | Glycerine | 5.87% |
| | Water | 64.62% |
| | Polysorbate 60 | 0.59% |
| | Total | 100% |

All the dry ingredients except titanium dioxide were dry blended in a mixer. All the liquid ingredients were blended in a separate mixture, to which titanium dioxide was then added and dispersed using a high shear mixer/homogenizer (mfr: Silverson Machines, Inc.; East Longmeadow, Mass.). Mixing was conducted for approximately 5 minutes. The liquid mixture was then added to the dry mixture and mixed until a well blended composition was achieved. The composition was then sieved through a fine mesh (size: 250 micrometers). The final composition was then made into substrates using either (1) an air operated spray gun (Ingersoll-Rand 672-067) or (2) a slot coater. Average thickness of each substrate varied from about 0.005 to about 0.025 inches.

The substrate sheets were oven dried in a series of heat treatments that averaged about 50° C. and totaled forty minutes of oven baking. The heat treatments were performed in an oven equipped with an infrared heating element (IRT-Monocassette w/Control Unit from Solaronics IRT S.A.; Armentieres, France). The composition layer was considered to be substantially non-flowable after some oven heating, and considered fully cured prior to applying an image thereon. The samples were considered stable and capable of being handled in various climate conditions.

### Example 4

A composition having the ingredients and amounts as provided below in Table 4 was prepared according to the procedure described in Example 3, except the citric acid was treated the same as titanium dioxide (i.e. added at a later stage).

TABLE 4

| | | % by wt. |
|---|---|---|
| Dry | Potassium Sorbate | 0.02% |
| Ingredients | Maize Starch | 13.93% |
| | Titanium Dioxide | 2.95% |
| | Modified Starch | 0.46% |
| | Icing Cane Sugar | 4.45% |
| | Dextrose Monohydrate | 3.72% |
| | Microcrystalline Cellulose | 5.65% |
| | Gum Acacia | 5.65% |
| Liquid | Glucose syrup | 8.45% |
| Ingredients | Glycerine | 3.32% |
| | Water | 49.83% |
| | Polysorbate 60 | 0.92% |
| | Sorbitol | 0.37% |
| | Citric Acid | 0.23% |
| | Vanilla Flavoring | 0.05% |
| | Total | 100% |

Substrate sheets were made from the composition using a slot coater, and heat treated according to the procedure described in Example 3. Samples were found to be stable and capable of being handled in various climate conditions.

### Example 5

A composition having the following ingredients and amounts as provided below in Table 5 was prepared according to the procedure described in Example 3.

TABLE 5

| | | % by wt. |
|---|---|---|
| Dry | Maize Starch | 10.10 |
| Ingredients | Gum Acacia | 10.10 |
| | Xanthan | 1.37 |
| | Titanium Dioxide | 0.13 |
| | Potassium Sorbate | 0.10 |
| | Sweeteners | 0.06 |
| Liquid | Water | 60.63 |
| Ingredients | Polysorbate 60 | 0.67 |
| | Sorbitol | 16.84 |
| | Total | 100 |

Substrate sheets were made from the composition according to the procedure described in Example 3. Samples were found to be stable and capable of being handled in various climate conditions.

A number of embodiments of the invention have been described. Nevertheless, it will be understood that various modifications may be made without departing from the spirit and scope of the invention. Accordingly, other embodiments are within the scope of the following claims.

What is claimed is:

1. An edible composition comprising:
an emulsifier;
a plasticizer;
a stabilizer;
a humectant;
a texturizer;
starch; and
water;
wherein the composition when formed into a substantially non-flowable substrate, is stable in an environment having a temperature about −35° C. to about 275° C., and a humidity level greater than about 5%.

2. The composition of claim 1 wherein the substrate is stable in an environment having a humidity level less than about 100%.

3. The composition of claim 1 wherein the substrate is stable in an environment having a temperature about −30° C. to about 27° C.

4. The composition of claim 1 wherein the substrate is substantially planar and is no more than about 650 μm (micrometers) thick.

5. The composition of claim 1 further comprising vegetable oil.

6. The composition of claim 1 further comprising at least one additive selected from a group consisting of a flavorant, a sweetener, a color enhancing agent, a food preservative and combinations thereof.

7. The composition of claim 1 further comprising a flavorant selected from a group consisting of vanilla, artificial vanilla flavoring, citric acid, and combinations thereof.

8. The composition of claim 1, further comprising a sweetener selected from a group consisting of sugar, glucose, glucose syrup, dextrose, sucrose, fructose, fructose syrup, sorbitol, aspartame, and combinations thereof.

9. The composition of claim 1 further comprising a color enhancing agent selected from a group consisting of a whitening agent, a dye, an ink and a pigment.

10. The composition of claim 9 wherein the color enhancing agent is titanium dioxide.

11. The composition of claim 1 further comprising a food preservative selected from a group consisting of citric acid, potassium sorbate, sorbic acid, sodium benzoate, EDTA and combinations thereof.

12. The composition of claim 1 wherein the emulsifier is selected from a group consisting of polysorbate, glycerin, lecithin, polyoxyethylene sorbitan monostearate, crillet, polyglycerol polyricinoleate, acetic esters of monoglycerides, and combinations thereof.

13. The composition of claim 1 wherein the emulsifier is present in the composition at up to about 10 wt % of the total composition.

14. The composition of claim 1 wherein the plasticizer is glycerin.

15. The composition of claim 1 wherein the plasticizer is present in the composition at up to about 10 wt % of the total composition.

16. The composition of claim 1 wherein the stabilizer is selected from a group consisting of locust bean gum, gum acacia, arabic gum, polysorbate, sodium alginate, starch, modified starch, xanthan, acetic esters of monoglycerides, polyglycerol polyricinoleate and combinations thereof.

17. The composition of claim 1 wherein the stabilizer is present in the composition at up to about 16 wt % of the total composition.

18. The composition of claim 1 wherein the humectant is selected from a group consisting of glycerin, sorbitol, xylitol, glucose syrup, sugar and combinations thereof.

19. The composition of claim 1 wherein the humectant is present in the composition at about 5 wt % to about 35 wt % of the total composition.

20. The composition of claim 1 wherein the texturizer is selected from a group consisting of acacia gum, arabic gum, glucose syrup, fructose syrup, and combinations thereof.

21. The composition of claim 1 wherein the texturizer is present in the composition at about 1 wt % to about 20 wt % of the total composition.

22. The composition of claim 1 further comprising a disintegrant.

23. The composition of claim 22 wherein the disintegrant is microcrystalline cellulose.

24. The composition of claim 22 wherein the disintegrant is present in the composition at up to about 12 wt % of the total composition.

25. The composition of claim 1 wherein the starch is derived from a material selected from a group consisting of maize, potato, wheat, and tapioca.

26. The composition of claim 1 wherein the starch is present in the composition at about 5 wt % to about 28 wt % of the total composition.

27. The composition of claim 5 wherein the oil is derived from a plant selected from a group consisting of rapeseed, corn, soy, and combinations thereof.

28. The composition of claim 5 wherein the oil is present in the composition at up to about 15 wt % of the total composition.

29. The composition of claim 1 wherein the water is present in the composition at about 25 wt % to about 70 wt % of the total composition.

30. An edible composition comprising:
up to about 10 wt % emulsifier;
up to about 10 wt % plasticizer;
up to about 16 wt % stabilizer;
about 5 wt % to about 35 wt % humectant;
about 1 wt % to about 20 wt % texturizer;
starch; and
water.

31. The composition of claim 30 wherein the starch is present in the composition at about 5 wt % to about 28 wt % of the total composition.

32. The composition of claim 30 wherein the water is present in the composition at about 25 wt % to about 70 wt % of the total composition.

33. The composition of claim 30 wherein the composition is processable through a slot coater.

34. The composition of claim 30 wherein the composition has a viscosity about 1000 to about 2000 cP and is processable by a spray applicator.

35. A substantially non-flowable substrate made from a composition of claim 30.

36. A substantially non-flowable substrate made from the composition of claim 1.

37. The substrate of claim 36 comprising an image placed on a surface of the substrate.

38. The substrate of claim 36 wherein the image bearing substrate expands when heated.

39. The substrate of claim 36 wherein the image-bearing substrate is stable when subjected to a cooking process selected from a group consisting of baking, frying, broiling, grilling and combinations thereof.

40. A method of making an image-bearable edible substrate for adherence an edible material, the method comprising:
blending a dry mixture comprising about 5 wt % to about 28 wt % starch, up to about 16 wt % stabilizer, and about 1 wt % to about 20 wt % texturizer;
blending a liquid mixture comprising about 25 wt % to about 70 wt % water, about 5 wt % to about 35 wt % humectant, up to about 10 wt % emulsifier, and up to about 10 wt % plasticizer;
combining the dry mixture and the liquid mixture to provide a flowable mixture; and
forming a substrate from said flowable mixture.

41. The method according to claim 40 wherein forming the substrate uses an apparatus selected from a group consisting of a sprayer, a slot coater, a roll coater, and a screen.

42. A method of making an image-bearable edible substrate for adherence on an edible material, the method comprising:
blending a dry mixture comprising starch, stabilizer, and texturizer;
blending a liquid mixture comprising water, humectant, emulsifier, and plasticizer;
heating a fatty phase comprising oil;
dispersing the heated fatty phase in the liquid mixture;
combining the dry mixture with the mixture of liquid and fatty phase; and,
forming a substrate that is stable in an environment having a temperature about −35° C. to about 275° C., and a humidity level of greater than about 5%.

43. The method according to claim 42 wherein the liquid mixture further comprises flavoring.

44. The method according to claim 42 wherein the dry mixture further comprises a disintegrant.

45. The method according to claim 42 wherein the dry mixture further comprises a coloring agent.

46. The method according to claim 42 wherein the dry mixture further comprises a preservative.

47. The method according to claim 42, further comprising:
allowing the substrate to achieve a substantially non-flowable state.

48. The method according to claim 47 further comprising:
applying an image on a surface of the substrate.

49. The method according to claim 48 wherein the image is applied to the surface using a process selected from a group consisting of silk screening, offset printing, ink jet printing, thermal transfer, and combinations thereof.

50. The method according to claim 42 wherein the formed substrate has a thickness of about 100 to about 650 micrometers.

51. The method according to claim 42 further comprising cutting the substrate.
